(19) United States
(12) Patent Application Publication
(10) Pub. No.: US 2026/0153481 A1
(43) Pub. Date: Jun. 4, 2026

(54) DISTRIBUTED ULTRASONIC MONITORING SYSTEM FOR INTERNAL FRACTURE PROCESS OF ULTRA-LARGE THREE-DIMENSIONAL GEOLOGICAL MODEL

(71) Applicant: Northeastern University, Shenyang City (CN)

(72) Inventors: Rui KONG, Shenyang City (CN); Xiating FENG, Shenyang City (CN); Xiwei ZHANG, Shenyang City (CN); Jingdong YANG, Shenyang City (CN); Zhenhua WU, Shenyang City (CN); Jun TIAN, Shenyang City (CN); Liangjie GU, Shenyang City (CN); Jianwei LU, Shenyang City (CN)

(21) Appl. No.: 18/728,781

(22) PCT Filed: Feb. 15, 2023
(86) PCT No.: PCT/CN2023/076070

§ 371 Date: Jul. 12, 2024

(30) Foreign Application Priority Data
Jan. 19, 2023 (CN) 202310058007.8

(51) Int. Cl. G01N 29/06; G01N 29/44

(52) U.S. Cl. CPC G01N 29/069; G01N 29/4472; G01N 2291/0232; G01N 2291/0289

(57) ABSTRACT

A distributed ultrasonic monitoring system for an internal fracture process of an ultra-large three-dimensional geological model includes a high-power ultrasonic phase control apparatus, ultrasonic transmitting and receiving integrated sensors, and measurement and control and three-dimensional ultrasonic imaging software. A geometric asymmetric monitoring layout mode is adopted to form a three-dimensional monitoring grid. The sensors are coupled with the three-dimensional geological model using a pre-embedded manner, the sensors according to sequential numbers are connected to the high-power ultrasonic phase control apparatus, and the sensors of each chain sensor array are excited one by one according to a pre-set delay time; and the three-dimensional ultrasonic imaging software inverts and analyzes a three-dimensional wave velocity field of the monitoring areas according to a relationship of echoes, transmission wave signals and the three-dimensional grid, and reflects rock fracture positions and degrees through changes in the wave velocity field.

### FIELD OF THE INVENTION

The present invention relates to the technical field of three-dimensional geological models, in particular to a distributed ultrasonic monitoring system for an internal fracture process of an ultra-large three-dimensional geological model.

### THE PRIOR ARTS

With resource extraction, hydropower development and development of transport construction, rock engineering faces deep construction challenges. Deep engineering rocks are in complex geological structures and true-triaxial high stress environment, under the action of high stress and excavation disturbance, rock explosion, collapse and other major engineering disasters occur frequently, but the deep engineering rocks fracture and a catastrophe breeding mechanism is still not effectively solved. Through a 5 m*5 m*5 m ultra-large three-dimensional geological model test, real-time monitoring of fracture signals, fracture time and fracture sources of rocks, can offer a scientific cognition of a mechanism of the whole process of deep engineering rock excavation and fracture, to provide an important basis for disaster early warning and prevention and control. Therefore, for monitoring of an internal fracture evolution of a model and a catastrophic process during the excavation of the ultra-large three-dimensional geological model, how to achieve high precision full-time monitoring of internal fracture of the model is a technical problem that needs to be solved urgently.

At current, monitoring of the three-dimensional geological model is dominated by stress, deformation and acoustic emission monitoring. Stress monitoring and deformation monitoring are carried out for measuring points or monitoring lines, and the obtained data is limited to an area of a certain measuring point or a certain monitoring line, and then deformation and damage characteristics of similar materials in the rocks are analyzed through a change trend of the characteristic curve of stress or deformation. As a result, monitoring tools based on deformation analysis are mostly based on local measurement point analysis, and are unable to perceive global damage information within a large three-dimensional geological model; moreover, based on deformation and stress monitoring, it is not possible to visually reflect the whole process of microfracture germination, and expansion until penetration and destruction during the excavation and fracture process of large geological models, and it is difficult to reveal the mechanism of rock catastrophe breeding. Acoustic emission monitoring can capture rock fracture signals in real time, but in the excavation process of large-scale three-dimensional geological models, it is impossible to accurately distinguish between peripheral rock fracture signals, excavation noise signals and disturbance signals, etc., and the accuracy of the monitored data is low. Due to limitations of acoustic emission and the accuracy of an acoustic emission positioning algorithm, the acoustic emission monitoring cannot accurately obtain the position of the rock fracture source. In view of high sensitivity of ultrasonic waves to rock mass fracture sources, ultrasonic monitoring has a large development potential in monitoring rock mass fracture sources, but the current ultrasonic monitoring of rock masses is mainly limited to wave velocity measurements in single holes or across holes, which cannot achieve monitoring of large-scale three-dimensional geological model fracture zones in a full-time spatial and spatial coverage manner, and cannot accurately and comprehensively obtain fracture evolution and catastrophic gestation processes of the three-dimensional geological model in the excavation process.

Because the ultra-large three-dimensional geological model is under the true-triaxial high stress condition, in the model excavation process, under the action of rock stress adjustment and redistribution around a hole, the inner part of the model is accompanied by emergence and expansion of micro-cracks, and rock bursts and other catastrophic processes is also a result of internal fracture of the rocks from quantitative changes to qualitative changes. At the same time, a pre-development stage of fracture germination within the three-dimensional geological model has the characteristics of small scale (mm-cm level), deep fracture, and monitoring difficulty. Therefore, there is a need to establish a full-time and spatial high-precision monitoring and method that can meet the monitoring demand for the rock fracture process of the ultra-large three-dimensional geological model, which is used to obtain real-time fracture inside the rocks in the excavation process of a large geological model, and to provide an effective means for analyzing a rock engineering catastrophe mechanism.

### SUMMARY OF THE INVENTION

Aiming at the defects existing in the prior art, the present invention provides a distributed ultrasonic monitoring system for an internal fracture process of an ultra-large three-dimensional geological model, which achieves three-dimensional high-precision monitoring of crack germination and expansion of a three-dimensional geological model in an internal fracture process by distributed ultrasonic monitoring and three-dimensional ultrasound imaging technologies.

In order to realize the above purpose, the present invention adopts the following technical scheme that the distributed ultrasonic monitoring system for the internal fracture process of the ultra-large three-dimensional geological model includes a high-power ultrasonic phase control apparatus, ultrasonic transmitting and receiving integrated sensors, and measurement and control and three-dimensional ultrasonic imaging software.

The high-power ultrasonic phase control apparatus includes an ultrasonic excitation and acquisition unit, an excitation and acquisition transfer switch, a power amplifier, and a signal amplifier; the ultrasonic excitation and acquisition unit is connected to the excitation and acquisition transfer switch which is connected to the power amplifier and the signal amplifier respectively; the power amplifier and the signal amplifier are both connected to the ultrasonic transmitting and receiving integrated sensors.

The ultrasonic excitation and acquisition unit selects an ultrasonic emission mode or an ultrasonic reception mode respectively through the ultrasonic excitation and acquisition transfer switch; when the ultrasonic emission mode is selected, the ultrasonic excitation and acquisition transfer switch is connected to the power amplifier, the ultrasonic excitation and acquisition unit emits ultrasonic pulse signals which are amplified by the power amplifier and transmitted to the ultrasonic transmitting and receiving integrated sensors; when the ultrasonic reception mode is selected, the ultrasonic excitation and acquisition transfer switch is connected to the signal amplifier, and after being amplified by the signal amplifier, signals received by the ultrasonic transmitting and receiving integrated sensors are acquired and stored by the ultrasonic excitation and acquisition unit.

The high-power ultrasonic phase control apparatus is provided with 128 monitoring channels, and the monitoring channels sequentially excite the ultrasonic transmitting and receiving integrated sensors according to a pre-set delay time, change a phase relationship of sound waves when reaching a certain point inside an object, and control direction changes of a sound beam, thereby achieving beam scanning, deflection, and focusing of ultrasonic waves, and improving monitoring accuracy.

The ultrasonic transmitting and receiving integrated sensors adopt a transmitting and receiving integrated chip and are pre-embedded in the ultra-large three-dimensional geological model; a plurality of ultrasonic transmitting and receiving integrated sensors are connected to form a chain sensor array; and on a same monitoring section, a plurality of chain sensor arrays are arranged to cover a monitoring area, and the ultrasonic transmitting and receiving integrated sensors of a plurality of monitoring sections jointly form a three-dimensional ultrasonic grid. The measurement and control and three-dimensional ultrasonic imaging software includes a monitoring and control software and a three-dimensional ultrasound imaging analysis software, the monitoring and control software controls excitation and acquisition of the high-power ultrasonic phase control apparatus, and the three-dimensional ultrasound imaging analysis software uses ultrasonic signals collected by the ultrasonic transmitting and receiving integrated sensors for three-dimensional wave velocity field inversion analysis and then achieves precise positioning of rock mass fracture sources through changes in a wave velocity field.

The distributed ultrasonic monitoring system for the internal fracture process of the ultra-large three-dimensional geological model is used for realizing a distributed ultrasonic monitoring method for an internal fracture process of an ultra-large three-dimensional geological model, wherein the method includes the following steps:

Step 1: determining key destruction areas, namely, key ultrasonic monitoring areas, according to boundary conditions and a rock mechanics theory.

Step 2: according to conditions of the key monitoring areas and a geological model excavation design scheme, adopting a geometric asymmetric monitoring layout mode, namely, arraying a relatively large number of the ultrasonic transmitting and receiving integrated sensors in the key monitoring areas; and at positions where damage is less prone to occur, arraying a relatively small number of the ultrasonic transmitting and receiving integrated sensors; setting 4-5 monitoring sections perpendicular to a tunnel axis in the monitoring areas along an excavation direction of the tunnel axis, with a distance of no more than 1 m between different monitoring sections, where each monitoring section is provided with 3-4 chain sensor arrays arranged in a fan-shaped manner, each chain sensor array is arranged in a straight line, a distance between the ultrasonic transmitting and receiving integrated sensors does not exceed 10 cm, the number of the ultrasonic transmitting and receiving integrated sensors is determined based on a monitoring depth, and the number of the ultrasonic transmitting and receiving integrated sensors in each chain sensor array is not less than 4; different monitoring section sensor groups are arranged in a staggered manner to form the three-dimensional ultrasonic monitoring grid; and in order to improve monitoring accuracy, the ultrasonic monitoring grid can be set in an encryption manner.

Step 3: according to a geometric asymmetric monitoring layout scheme, coupling the ultrasonic transmitting and receiving integrated sensors with the ultra-large three-dimensional geological model using a pre-embedded manner, connecting the ultrasonic transmitting and receiving integrated sensors according to sequential numbers to the high-power ultrasonic phase control apparatus, and then, exciting the ultrasonic transmitting and receiving integrated sensors of each chain sensor array one by one according to a pre-set delay time, wherein when a certain ultrasonic transmitting and receiving integrated sensor is excited, other ultrasonic transmitting and receiving integrated sensors in a same chain sensor array use an echo monitoring mode, while the ultrasonic transmitting and receiving integrated sensors on different chain sensor arrays use a transmission monitoring mode, the three-dimensional ultrasonic monitoring grid is formed between every two ultrasonic transmitting and receiving integrated sensors, and the ultrasonic transmitting and receiving integrated sensors on the same chain sensor array are controlled in excitation number, positions and excitation time, thereby controlling deflection and focusing of an ultrasonic emission beam, changing the phase relationship of the sound wave reaching the rock mass fracture sources, and improving monitoring accuracy.

Step 4: enabling the three-dimensional ultrasound imaging analysis software to invert and analyze a three-dimensional wave velocity field of the monitoring areas according to a relationship of echoes, transmission wave signals and the three-dimensional ultrasonic monitoring grid, in combination with a reflection-transmission integrated imaging algorithm, and then reflect rock fracture positions and degrees through changes in the wave velocity field.

The reflection-transmission integrated imaging algorithm lies in that the ultrasonic transmitting and receiving integrated sensors use both the echo monitoring mode and the transmission monitoring mode, and combine the echo signals and transmission wave signals for ultrasonic imaging.

The present invention has the following beneficial effects by using the technical solution:

The present invention provides a distributed ultrasonic monitoring system for an internal fracture process of an ultra-large three-dimensional geological model. Compared with the prior art, the distributed ultrasonic monitoring system adopts the high-power ultrasonic phase control apparatus to solve the problem of low precision of high-frequency ultrasonic testing due to a large ultrasonic attenuation of a rock material; through the distributed monitoring, a three-dimensional ultrasonic monitoring grid is constructed, and in combination with a reflection-transmission integrated imaging algorithm, the high-precision monitoring of the fracture source and fracture degree of the rock masses is effectively realized.

### BRIEF DESCRIPTION OF DRAWINGS

FIG. 1 shows a diagram of a monitoring principle of a distributed ultrasonic monitoring system for an internal fracture process of an ultra-large three-dimensional geological model of the present invention; and

FIG. 2 shows a schematic diagram of ultrasonic monitoring of a certain section of the distributed ultrasonic monitoring system for the internal fracture process of the ultra-large three-dimensional geological model of the present invention.

In the drawings, 1: ultra-large three-dimensional geological model; 2: tunnel chamber; 3: ultrasonic transmitting and receiving integrated sensor; 4: high-power ultrasonic phase control apparatus; 5: chain sensor array; and 6: three-dimensional ultrasonic monitoring grid.

### DETAILED DESCRIPTION OF THE PREFERRED EMBODIMENT

Specific embodiments of the present invention are described in further detail below in connection with the accompanying drawings and embodiments. The following embodiments are used to illustrate the present invention, but are not intended to limit the scope of the present invention.

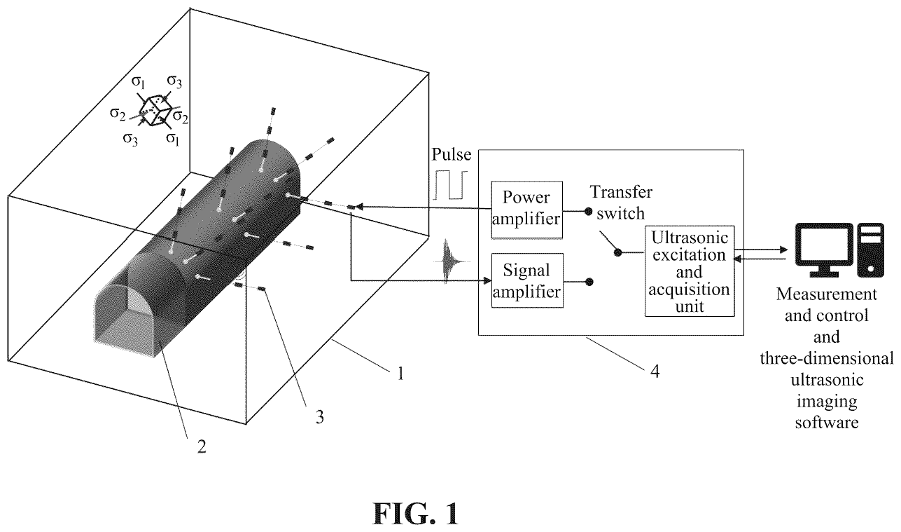

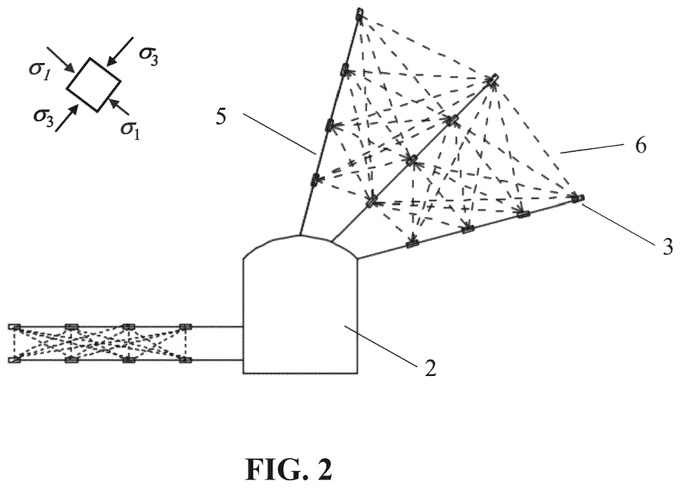

As shown in FIG. 1 and FIG. 2, a distributed ultrasonic monitoring system for an internal fracture process of an ultra-large three-dimensional geological model 1 includes a high-power ultrasonic phase control apparatus 4, ultrasonic transmitting and receiving integrated sensors 3, and measurement and control and three-dimensional ultrasonic imaging software. The high-power ultrasonic phase control apparatus 4 includes an ultrasonic excitation and acquisition unit, an excitation and acquisition transfer switch, a power amplifier, and a signal amplifier; the ultrasonic excitation and acquisition unit is connected to the excitation and acquisition transfer switch which is connected to the power amplifier and the signal amplifier respectively; the power amplifier and the signal amplifier are both connected to the ultrasonic transmitting and receiving integrated sensors 3; the ultrasonic excitation and acquisition unit selects an ultrasonic emission mode or an ultrasonic reception mode respectively through the ultrasonic excitation and acquisition transfer switch; when the ultrasonic emission mode is selected, the ultrasonic excitation and acquisition transfer switch is connected to the power amplifier, the ultrasonic excitation and acquisition unit emits ultrasonic pulse signals which are amplified by the power amplifier and transmitted to the ultrasonic transmitting and receiving integrated sensors 3; when the ultrasonic reception mode is selected, the ultrasonic excitation and acquisition transfer switch is connected to the signal amplifier, and after being amplified by the signal amplifier, signals received by the ultrasonic transmitting and receiving integrated sensors 3 are acquired and stored by the ultrasonic excitation and acquisition unit. The high-power ultrasonic phase control apparatus 4 is provided with 128 monitoring channels, each monitoring channel is connected to one ultrasonic transmitting and receiving integrated sensor 3, and the monitoring channels sequentially excite the ultrasonic transmitting and receiving integrated sensors 3 according to a pre-set delay time, change a phase relationship of sound waves when reaching a certain point inside an object, and control direction changes of a sound beam, thereby achieving beam scanning, deflection, and focusing of ultrasonic waves, and improving monitoring accuracy.

The ultrasonic transmitting and receiving integrated sensors 3 adopt a transmitting and receiving integrated chip and are pre-embedded in the ultra-large three-dimensional geological model 1; a plurality of ultrasonic transmitting and receiving integrated sensors 3 are connected to form a chain sensor array 5; and on a same monitoring section, a plurality of chain sensor arrays 5 are arranged to cover a monitoring area, and the ultrasonic transmitting and receiving integrated sensors 3 of a plurality of monitoring sections jointly form a three-dimensional ultrasonic monitoring grid 6.

The measurement and control and three-dimensional ultrasonic imaging software includes a monitoring and control software and a three-dimensional ultrasound imaging analysis software, the monitoring and control software controls excitation and acquisition of the high-power ultrasonic phase control apparatus 4, and the three-dimensional ultrasound imaging analysis software uses ultrasonic signals collected by the ultrasonic transmitting and receiving integrated sensors 3 for three-dimensional wave velocity field inversion analysis and then achieves precise positioning of rock mass fracture sources through changes in a wave velocity field.

A monitoring method for the distributed ultrasonic monitoring system for the internal fracture process of the ultra-large three-dimensional geological model 1 includes the following steps:

Step 1: according to a relationship between a direction of main stress and a tunnel axis, a right arch shoulder and a left wall of a tunnel chamber 2 are key monitoring areas.

Step 2: a geometrically asymmetric monitoring arrangement manner is used in the left wall and the right arch shoulder as shown in FIG. 2; the right arch shoulder is provided with 3 chain sensor arrays 5 in a fan-shaped manner, where each chain sensor array 5 is arranged in a straight line, the distance between the ultrasonic transmitting and receiving integrated sensors 3 is 10 cm, and the number of the sensors 3 in each chain sensor array 5 is 4.

Step 3: according to a geometric asymmetric monitoring layout scheme, the ultrasonic transmitting and receiving integrated sensors 3 are coupled with the three-dimensional geological model 1 using a pre-embedded manner, the ultrasonic transmitting and receiving integrated sensors 3 according to sequential numbers are connected to the high-power ultrasonic phase control apparatus 4, and then, the ultrasonic transmitting and receiving integrated sensors 3 of each chain sensor array 5 are excited one by one according to a pre-set delay time; when a certain ultrasonic transmitting and receiving integrated sensor 3 is excited, other ultrasonic transmitting and receiving integrated sensors 3 in a same chain sensor array 5 use an echo monitoring mode, while the ultrasonic transmitting and receiving integrated sensors 3 on different chain sensor arrays 5 use a transmission monitoring mode, thereby forming the three-dimensional ultrasonic monitoring grid 6 between every two ultrasonic transmitting and receiving integrated sensors 3; and the ultrasonic transmitting and receiving integrated sensors 3 on the same chain sensor array 5 be controlled in excitation number, positions and excitation time, thereby controlling deflection and focusing of an ultrasonic emission beam, changing the phase relationship of the sound wave reaching the rock mass fracture sources, and improving monitoring accuracy.

Step 4: the three-dimensional ultrasound imaging analysis software inverts and analyzes a three-dimensional wave velocity field of the monitoring areas according to a relationship of echoes, transmission wave signals and the three-dimensional ultrasonic monitoring grid, in combination with a reflection-transmission integrated imaging algorithm, and then reflects rock fracture positions and degrees through changes in the wave velocity field. The above description is only a preferred embodiment of the present disclosure and an illustration of the technical principles employed. It should be understood by those skilled in the art that the scope of the present invention involved in the embodiments of the present disclosure is not limited to a technical solution formed by a particular combination of the above-described technical features, but should also cover other technical solutions formed by any combination of the above-described technical features or their equivalent without departing from the above-described inventive concept. For example, a technical solution formed by interchanging the above features with (but not limited to) technical features having similar functions disclosed in embodiments of the present disclosure.

1. A distributed ultrasonic monitoring system for an internal fracture process of an ultra-large three-dimensional geological model, comprising a high-power ultrasonic phase control apparatus, ultrasonic transmitting and receiving integrated sensors, and measurement and control and three-dimensional ultrasonic imaging software, wherein
the high-power ultrasonic phase control apparatus comprises an ultrasonic excitation and acquisition unit, an excitation and acquisition transfer switch, a power amplifier, and a signal amplifier; the ultrasonic excitation and acquisition unit is connected to the excitation and acquisition transfer switch which is connected to the power amplifier and the signal amplifier respectively; the power amplifier and the signal amplifier are both connected to the ultrasonic transmitting and receiving integrated sensors;
the ultrasonic transmitting and receiving integrated sensors adopt a transmitting and receiving integrated chip and are pre-embedded in the ultra-large three-dimensional geological model; a plurality of ultrasonic transmitting and receiving integrated sensors are connected to form a chain sensor array; on a same monitoring section, a plurality of chain sensor arrays are arranged to cover a monitoring area, and the ultrasonic transmitting and receiving integrated sensors of a plurality of monitoring sections jointly form a three-dimensional ultrasonic monitoring grid; and
the measurement and control and three-dimensional ultrasonic imaging software comprises a monitoring and control software and a three-dimensional ultrasound imaging analysis software, the monitoring and control software controls excitation and acquisition of the high-power ultrasonic phase control apparatus, and the three-dimensional ultrasound imaging analysis software uses ultrasonic signals collected by the ultrasonic transmitting and receiving integrated sensors for three-dimensional wave velocity field inversion analysis and then achieves precise positioning of rock mass fracture sources through changes in a wave velocity field,
wherein the ultrasonic excitation and acquisition unit selects an ultrasonic emission mode or an ultrasonic reception mode respectively through the ultrasonic excitation and acquisition transfer switch; when the ultrasonic emission mode is selected, the ultrasonic excitation and acquisition transfer switch is connected to the power amplifier, the ultrasonic excitation and acquisition unit emits ultrasonic pulse signals which are amplified by the power amplifier and transmitted to the ultrasonic transmitting and receiving integrated sensors; and when the ultrasonic reception mode is selected, the ultrasonic excitation and acquisition transfer switch is connected to the signal amplifier, and after being amplified by the signal amplifier, signals received by the ultrasonic transmitting and receiving integrated sensors are acquired and stored by the ultrasonic excitation and acquisition unit:
wherein the high-power ultrasonic phase control apparatus is provided with 128 monitoring channels, and the monitoring channels sequentially excite the ultrasonic transmitting and receiving integrated sensors according to a pre-set delay time, change a phase relationship of sound waves when reaching a certain point inside an object, and control direction changes of a sound beam, thereby achieving beam scanning, deflection, and focusing of ultrasonic waves, and improving monitoring accuracy; and
wherein the distributed ultrasonic monitoring system is used for realizing a distributed ultrasonic monitoring method for the internal fracture process of the ultra-large three-dimensional geological model, the method comprises the following steps:
Step 1: determining key destruction areas, namely, key ultrasonic monitoring areas. according to boundary conditions and a rock mechanics theory:
Step 2: according to conditions of the key monitoring areas and a geological model excavation design scheme, adopting a geometric asymmetric monitoring layout mode, namely. arraying a relatively large number of the ultrasonic transmitting and receiving integrated sensors in the key monitoring areas; and at positions where damage is less prone to occur, arraying a relatively small number of the ultrasonic transmitting and receiving integrated sensors;
Step 3: according to a geometric asymmetric monitoring layout scheme, coupling the ultrasonic transmitting and receiving integrated sensors with the ultra-large three-dimensional geological model using a pre-embedded manner, connecting the ultrasonic transmitting and receiving integrated sensors according to sequential numbers to the high-power ultrasonic phase control apparatus, and then, exciting the ultrasonic transmitting and receiving integrated sensors of each chain sensor array one by one according to a pre-set delay time; and
Step 4: enabling the three-dimensional ultrasound imaging analysis software to invert and analyze a three-dimensional wave velocity field of the monitoring areas according to a relationship of echoes, transmission wave signals and the three-dimensional ultrasonic monitoring grid, in combination with a reflection-transmission integrated imaging algorithm, and then reflect rock fracture positions and degrees through changes in the wave velocity field.

2. (canceled)

3. (canceled)

4. (canceled)

5. The distributed ultrasonic monitoring system for the internal fracture process of the ultra-large three-dimensional geological model according to claim 1, wherein Step 2 comprises:
setting 4-5 monitoring sections perpendicular to a tunnel axis in the monitoring areas along an excavation direction of the tunnel axis, with a distance of no more than 1 m between different monitoring sections, wherein each monitoring section is provided with 3-4 chain sensor arrays arranged in a fan-shaped manner, each chain sensor array is arranged in a straight line, a distance between the ultrasonic transmitting and receiving integrated sensors does not exceed 10 cm, the number of the ultrasonic transmitting and receiving integrated sensors is determined based on a monitoring depth, and the number of the ultrasonic transmitting and receiving integrated sensors in each chain sensor array is not less than 4;
different monitoring section sensor groups are arranged in a staggered manner to form the three-dimensional ultrasonic monitoring grid; and
in order to improve monitoring accuracy, the ultrasonic monitoring grid is set in an encryption manner.

6. The distributed ultrasonic monitoring system for the internal fracture process of the ultra-large three-dimensional geological model according to claim 1, wherein the excitation in Step 3 lies in that when a certain ultrasonic transmitting and receiving integrated sensor is excited, other ultrasonic transmitting and receiving integrated sensors in a same chain sensor array use an echo monitoring mode, while the ultrasonic transmitting and receiving integrated sensors on different chain sensor arrays use a transmission monitoring mode, thereby forming the three-dimensional ultrasonic monitoring grid between every two ultrasonic transmitting and receiving integrated sensors; and the ultrasonic transmitting and receiving integrated sensors on the same chain sensor array are controlled in excitation number, positions and excitation time, thereby controlling deflection and focusing of an ultrasonic emission beam, changing the phase relationship of the sound wave reaching the rock mass fracture sources, and improving monitoring accuracy.

7. The distributed ultrasonic monitoring system for the internal fracture process of the ultra-large three-dimensional geological model according to claim 1, wherein the reflection-transmission integrated imaging algorithm in Step 4 lies in that the ultrasonic transmitting and receiving integrated sensors use both the echo monitoring mode and the transmission monitoring mode, and combine echo signals and transmission wave signals for ultrasonic imaging.
